(19) United States
(12) Patent Application Publication
(10) Pub. No.: US 2021/0331816 A1
(43) Pub. Date: Oct. 28, 2021

(54) DEVICE FOR GENERATING A VARIABLE ANGULAR MOMENTUM, IN PARTICULAR FOR SPACECRAFT ATTITUDE CONTROL

(71) Applicant: UNIVERSITÄT STUTTGART, Stuttgart (DE)

(72) Inventors: Manfred EHRESMANN, Stuttgart (DE); Georg Heinrich HERDRICH, Esslingen (DE); Stefanos FASOULAS, Neckartenzlingen (DE)

(21) Appl. No.: 17/242,359

(22) Filed: Apr. 28, 2021

(30) Foreign Application Priority Data
Apr. 28, 2020 (EP) 20 171 813.7

(51) Int. Cl. B64G 1/24; B64G 1/28

(52) U.S. Cl. CPC B64G 1/244; B64G 1/28

(57) ABSTRACT

The present invention relates to a device for generating a variable angular momentum or torque, which has a container (1) partially filled with a magnetizable fluid (2) and a device for generating one or several rotating or wandering magnetic fields, with which the magnetizable fluid (2) in the container (1) can be made to continuously move on a closed orbit. The device for generating the rotating or wandering magnetic fields has several electric coils (4), whose coil axes lie in the orbital plane. This structure makes it possible to generate a variable angular momentum without mechanical moved parts or the necessity of external magnetic fields. For example, the device enables a simple and cost-effective spacecraft attitude control.

### TECHNICAL FIELD OF APPLICATION

The present invention relates to a device for generating a variable angular momentum, which has a container partially filled with a magnetizable fluid and a device for generating at least one rotating magnetic field, with which the magnetizable fluid in the container can be made to continuously move on a closed orbit. For example, such a device can be used for spacecraft attitude control.

### PRIOR ART

During the operation of spacecraft, it is often necessary to provide one or several devices on the spacecraft with which the position of the spacecraft can be specifically changed or corrected. For example, this can take place via a propulsion system of the aircraft, which generates an angular momentum by way of an eccentric thrust. It is further known to equip spacecraft with mechanical swirl and reaction wheels. An angular momentum is here stored in a rapidly rotating flywheel, and transferred to the spacecraft when needed by accelerating or decelerating the flywheel. Given the presence of an external magnetic field, such as that of the earth, a magnetic field generated on the spacecraft itself can generate a reactive torque. The latter is usually generated by an energized coil.

However, mechanical swirl and reaction wheels are very expensive to manufacture, since very high requirements are placed on tolerances and concentricity properties. Such mechanical systems can also easily fail, and only have a limited lifetime. Generating a reactive torque with a self-generated magnetic field requires the proximity of a celestial body with a relevant magnetic field. The effectiveness here also depends on the position and orbit of the spacecraft. A propulsion system for generating the angular momentum consumes fuel, and is thus only limitedly available. The fuel mass additionally increases the start costs of the spacecraft. A propulsion system often only offers limited possibilities for high-precision attitude control.

M. Ehresmann et al., “PAPELL: Mechanic-free Actuators through Ferrofluids”, 12th IAA Symposium on Small Satellites for Earth Observation, Berlin, May 2019, describes a technique for generating a variable angular momentum, in which a ferrofluid is moved in a circular tube by two groups of respective four electromagnets on a circular orbit. The electromagnets are here configured as pot magnets, whose coil axis is aligned perpendicularly to the orbital plane of the moved ferrofluid. The magnets are each turned on and off in a respectively suitable chronological sequence, so as to move the fluid on the circular orbit. In this embodiment, however, the ferrofluid is only transported from one respective magnet to the next, and there decelerated again by the magnets, so that a large enough angular momentum cannot be generated.

The object of the present invention is to provide a device for generating a variable angular momentum that is suitable for spacecraft attitude control, does without mechanical components, external magnetic fields, or additional fuel, and makes it possible to generate and change a large enough angular momentum or torque.

### DESCRIPTION OF THE INVENTION

The object is achieved with the device according to claim 1. Advantageous embodiments of the device are the subject of the dependent claims, or can be derived from the following description as well as the exemplary embodiments.

The proposed device has a container that is only partially filled with a magnetizable fluid, in particular a ferrofluid, and a device for generating one or several rotating or wandering magnetic fields, with which the magnetizable fluid in the container can be made to continuously move on a closed path. The remaining interior volume of the container only partially filled with the magnetizable fluid is filled up with a gaseous medium, e.g., air, or a liquid medium, which does not mix with the magnetizable fluid. The device for generating the one or the several rotating or wandering magnetic fields has several electric coils for generating the magnetic fields, whose coil axes lie in the orbital plane of the closed movement path of the magnetizable fluid. The device for generating the one or several rotating or wandering magnetic fields also comprises a controller, with which a phase-shifted current flow through the electric coils can be generated and controlled or regulated. The controller is here preferably configured in such a way that it can generate a phase-offset, sinusoidal current flow through the coils.

The arrangement of electric coils makes it possible to generate one or several rotating or wandering magnetic fields, which magnetize(s) the magnetizable fluid in the container, and continuously move(s) it on a closed orbit in the container via the rotation or movement of the magnetic field(s). As a result, this liquid generates an angular momentum, the strength of which depends among other things on the speed at which the magnetizable fluid moves on the closed orbit. Controlling the speed at which the magnetic field or magnetic fields rotate(s) or move(s) makes it possible to vary this speed of movement, and hence the angular momentum, and thereby to generate a torque. If this device is used in a spacecraft, the angular momentum generated in this device transfers an opposite angular momentum to the spacecraft. As a result, the position and orientation of the spacecraft in space can be controlled.

In an advantageous embodiment, the container extends around a central area of the device, wherein the electric coils are arranged in the central area. The container here preferably forms a continuous channel around the central area, for example an annular or elliptical channel. The channel cross section can here have any shape desired, for example rectangular or circular.

In another embodiment, the container is located in the central area, and the coils are arranged around the container. In both cases, the coil axes are each aligned perpendicularly to the next section of the closed orbit on which the magnetic fluid is to move. In the case of a container that forms an annular channel around the central area, the coil axes are thus arranged in the central area in a stellate manner.

In a further embodiment, only a part of the container is enveloped by coils for actively moving ferrofluid. No coils or coil pairs are located on other sections of the container. The movement here is only reached through momentum transfer within the media or liquids.

In an advantageous embodiment, the interior volume of the container remaining due to the only partial filling with the magnetizable fluid is filled up with a liquid medium, which has a higher density than the magnetizable fluid, and does not mix with the latter. This liquid medium is likewise moved on the closed orbit by the movement of the magnetizable fluid, and thereby elevates the angular momentum. A metallic material with a density of ≥6 g·cm⁻³ that is liquid at room temperature (20° C.) is here preferably used as the liquid medium. It is here especially advantageous to use mercury or a eutectic alloy of gallium and indium or gallium, indium, and tin. A ferrofluid is preferably used as the magnetizable fluid.

In the proposed device, the container can also be filled with the magnetizable fluid in such a way that several partial volumes of the magnetizable fluid separated from each other by a liquid or gaseous medium are present, which partial volumes of the magnetizable fluid circulate on the closed orbit separately from each other. The process of controlling the device for generating one or several rotating or wandering magnetic fields is here preferably adjusted in such a way that all of these partial volumes are correspondingly driven by magnetic fields.

The individual coils can have suitable core materials for elevating the magnetic field strengths, for example iron cores. Furthermore, the device can also have a magnetic shield to shield the outer area from the generated magnetic fields. The proposed device uses the magnetic movement of the magnetizable liquid on a closed orbit to store an angular momentum. By specifically changing the speed of the liquid using the device for generating the one or the several rotating or wandering magnetic fields, the stored angular momentum is changed, and as a result, given use in a spacecraft, so too is the angular momentum transferred to the spacecraft. It is also possible to reverse the angular momentum by 180° by reversing the direction of rotation or movement of the magnetic field or magnetic fields. As a consequence, the proposed device can be used to realize spacecraft attitude control tasks without mechanical components or external magnetic fields in a simple, reliable, and cost-effective manner. The device requires no mechanically moved components, and by comparison to mechanical solutions is subject to distinctly less wear and has a higher lifetime and reliability. The device can be used not just for spacecraft attitude control, but also for other applications, for which a variable angular momentum is to be generated and transferred, for example as an actuator on a robot arm.

### BRIEF DESCRIPTION OF THE DRAWINGS

The proposed device will be exemplarily described in more detail once more below based on exemplary embodiments in conjunction with the drawings. Shown here on:

FIG. 1 is an exemplary structure of the proposed device, as well as three phases of the movement of the magnetizable fluid;

FIG. 2 is a schematic illustration of another example for a structure of the proposed device;

FIG. 3 is a schematic illustration of another example for a structure of the proposed device; and

FIG. 4 is a schematic illustration of another example for a structure of the proposed device.

### WAYS OF IMPLEMENTING THE INVENTION

The principle of the proposed device is based on a magnetizable liquid being magnetized by locally sufficiently strong magnetic fields, and attracted by these magnetic fields. The magnetized liquid can be correspondingly moved by specifically displacing the positions of high magnetic field strength. In the proposed device, one or several rotating or wandering magnetic fields are now used to make the magnetizable liquid continuously move on a closed orbit, and thereby generate an angular momentum. This is achieved via the suitable arrangement and control of electric coils, whose coil axes lie in the orbital plane.

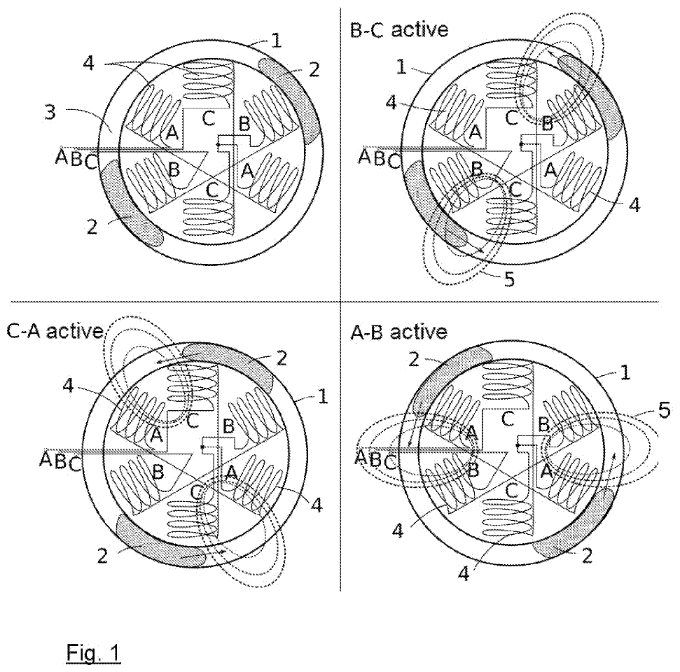

Shown in cross section on FIG. 1 is a first example for the structure of the proposed device. FIG. 1a here shows an annularly designed container 1, which forms a closed channel around the central area of the device, and is partially filled with a ferrofluid 2. In this example, the container 1 is filled with the ferrofluid 2 in such a way that two partial volumes of the ferrofluid separated from each other are present, which are separated from each other by a liquid or gaseous medium 3. The annular container 1 envelops a central area in which six coils 4 are arranged in a stellate manner with their axes, as evident from FIG. 1a. A respective two opposing coils 4 form a coil pair connected with each other. The respective open first ends A, B, C of the coil pairs can be put under a voltage by an undepicted controller, so that a current flows through the respective coil pairs. The second ends are here connected with a common ground connection. A suitable phase-offset control of the individual coil pairs by means of the controller makes it possible to generate two rotating magnetic fields 5, through which each of the two partial volumes of the ferrofluid 2 are moved on an annular orbit defined by the container 1. The coil axes of the coils 4 here all lie within the orbital plane of this orbit.

The generation of the rotating magnetic fields and resultant movement of the ferrofluid are illustrated based on FIGS. 1b-1d. On FIG. 1b, the ends B and C are first put under a voltage by the controller. The current flow thereby generated in the corresponding coil pairs produces the magnetic fields 5 depicted on the figure. As a result, each of the two partial volumes of the ferrofluid 2 flows in the direction of the respective magnetic field 5, as denoted on the figure by the arrows. Since this process takes place symmetrically, an angular momentum is stored in the system, and a torque is exerted. This makes it possible to realize attitude control for a spacecraft in which this device is used. FIGS. 1c and 1d show the continuation of this process by applying the voltage to the ends C and A or A and B. In turn, the figures show the respective magnetic fields 5 this generates and movements of the ferrofluid 2. The individual coil pairs of the device are here preferably controlled by the controller in such a way as to yield a continuous and uniform rotation of the magnetic fields 5. To this end, the controller preferably generates a sinusoidal multiphase alternating current, in the present example a three-phase alternating current using three coil pairs.

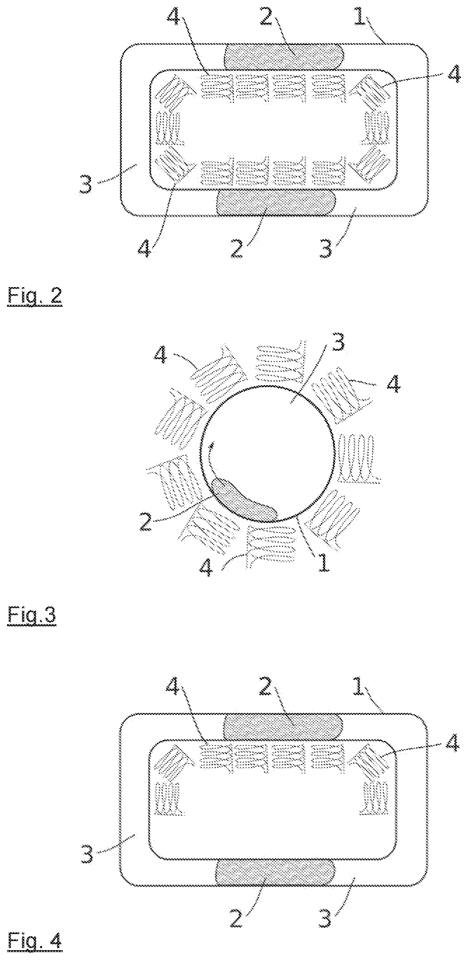

The number of electric coils or coil groups is not limited to the quantity shown on FIG. 1. Rather, more than two coils per group or even more than three groups of coils can also be used. A group formation is also not necessary in each case. The individual coils can also be controlled individually, independently of each other. Depending on how the ferrofluid is allocated, this independent control may also be necessary. Furthermore, it is of course also possible that the container 1 not be annular, but instead be configured with another shape, as exemplarily denoted schematically on FIG. 2. On this figure, the container 1 again forms a channel around a central area, in which the individual coils 4 suitable for generating two rotating magnetic fields are arranged.

The coils 4 can also be arranged around the container 1, as schematically denoted based on an example on FIG. 3. In this case, for example, the container 1 has a disk-shaped design in a central area of the device, wherein the coils 4 are arranged with their coil axes around the container 1 in a stellate manner in this example. In this example as well, the ferrofluid 2 can be moved on a closed orbit by a rotating magnetic field.

The coils 4 need not be arranged completely around the container 1 or along the closed orbit. This is shown by example on FIG. 4 as a modification of the embodiment on FIG. 3, but can naturally be applied to other embodiments, for example the one on FIG. 1 or FIG. 2. The movement of the ferrofluid 2 in the orbit area without coils here takes place by momentum transfer within the media 2, 3 in the container 1.

### REFERENCE LIST

1 Container
2 Ferrofluid
3 Liquid or gaseous medium
4 Coil
5 Magnetic field
A, B, C Ends of the coils

1. A device for generating a variable angular momentum, in particular for spacecraft attitude control, which
has a container (1) partially filled with a magnetizable fluid (2) and
a device for generating at least one rotating or wandering magnetic field, with which the magnetizable fluid (2) in the container (1) can be made to continuously move on a closed orbit in an orbital plane,
wherein the device for generating at least one rotating or wandering magnetic field has several electric coils (4) for generating the magnetic field, whose coil axes lie in the orbital plane, and
a controller, with which a phase-shifted current flow through the electric coils (4) can be generated and controlled or regulated.

2. The device according to claim 1,
characterized in that
the container (1) extends around a central area of the device and the electric coils (4) are arranged in the central area.

3. The device according to claim 1,
characterized in that
the electric coils (4) are arranged around the container (1).

4. The device according to claim 2,
characterized in that
the container (1) forms a closed channel around the central area.

5. The device according to claim 4,
characterized in that
the container (1) is annularly formed around the central area.

6. The device according to claim 1,
characterized in that
the coil axes each are aligned perpendicularly to a next section of the closed orbit.

7. The device according to claim 1,
characterized in that
an interior volume of the container (1) remaining due to the only partial filling with the magnetizable fluid (2) is filled up with a liquid medium, which has a higher density than the magnetizable fluid (2), and does not mix with the magnetizable fluid (2).

8. The device according to claim 7,
characterized in that
the liquid medium is a metallic material with a density of ≥6 g·cm⁻³, in particular mercury or a eutectic alloy of gallium and indium or gallium, indium, and tin.

9. The device according to claim 1,
characterized in that
the container (1) is filled with the magnetizable fluid (2) in such a way that several partial volumes of the magnetizable fluid (2) separated from each other are present.

10. The device according to claim 1,
characterized in that
the controller is designed in such a way that it can generate a phase-offset sinusoidal current flow through the coils (4).

11. The device according to claim 1,
characterized in that
the container (1) is filled with the magnetizable fluid (2) in such a way that several partial volumes of the magnetizable fluid (2) separated from each other are present.
